(19) United States
(12) Patent Application Publication
(10) Pub. No.: US 2007/0297433 A1
(43) Pub. Date: Dec. 27, 2007

(54) METHOD AND APPARATUS FOR DOUBLE BUFFERING

(75) Inventors: Meng Ting Lin, Hsinchu City (TW); Cheng-Ting Wu, Hsinchu City (TW)

Correspondence Address: THOMAS, KAYDEN, HORSTEMEYER & RISLEY, LLP, 600 GALLERIA PARKWAY, STE 1500, ATLANTA, GA, 30339, US

(73) Assignee: MEDIATEK INC., Hsin-Chu (TW)

(21) Appl. No.: 11/426,325

(22) Filed: Jun. 26, 2006

(51) Int. Cl. H04L 12/56

(52) U.S. Cl. 370/412; 370/465

(57) ABSTRACT

A double buffering device and operating method thereof are provided to provide data to a second device, comprising a controller, a first buffer and a second buffer, a bus and a software unit. The controller controls data access. The first and second buffers coupled to the controller store the data. The bus is coupled to the controller for data delivery. The software unit provides data to the buffers via the bus. In a first mode, the software unit programs the first buffer with the data, the controller synchronizes the data from the first buffer to the second buffer, and the controller copies the data from the second buffer to the second device. In a second mode, the software unit simultaneously programs the first and second buffers with the data, and the controller copies the data from the second buffer to the second device.

### BACKGROUND

The invention relates to double buffering, and in particular, to a double buffering device implemented by random access memory and the operating method thereof.

Double buffering is a buffering technique for transferring data between devices with different processing speeds.

FIG. 1 is a conventional double buffering diagram. Two buffers, first buffer 120 and second buffer 130 are provided. A software unit 110 provides data to a client module 140 via the first buffer 120 and second buffer 130. When the client module 140 reads current data in the second buffer 130, the software unit 110 pre-writes next data to the first buffer 120. Alternatively, when the client module 140 reads data stored in the first buffer 120, the software unit 110 pre-writes further data to the second buffer 130. The architecture is referred to as ping-pong type double buffering.

In some specific cases, the data variation rate is low, thus, the buffers do not require frequent update. The ping-pong type architecture, however, updates each buffer regardless of whether an update is required. System resources are therefore unnecessarily expended, and an enhanced architecture is desirable.

### SUMMARY

An exemplary embodiment of a double buffering device is provided, providing data to a second device, comprising a controller, a first buffer and a second buffer, a bus, and a software unit. The controller controls data access. The first and second buffers coupled to the controller store the data. The bus is coupled to the controller for data delivery. The software unit provides data to the buffers via the bus. In a first mode, the software unit programs the first buffer with the data, the controller synchronizes the data from the first buffer to the second buffer, and the controller copies the data from the second buffer to the second device. In a second mode, the software unit simultaneously programs the first and second buffers with the data, and the controller copies the data from the second buffer to the second device.

The first and second buffers include random access memory (RAM) devices. The data comprises a plurality of bytes stored in the first buffer, and the controller synchronizes the first and second buffers by the following steps. A busy flag is first enabled indicating that the buffers are occupied. The data is then recursively read byte by byte in the first buffer, and written byte by byte to the second buffer. The busy flag is disabled when the synchronization is complete.

When a data access request is received from the second device, the controller determines whether the synchronization is in proves. If the synchronization is in process, the controller suspends the synchronization, copies the data from the second buffer to the second device, and restores the synchronization when copying is complete. If the synchronization is not in process, the controller enables the busy flag, copies the data from the second buffer to the second device, and disables the busy flag when the copying is complete.

In the first mode, the software unit requests the controller for programming the first buffer, and the controller determines whether the busy flag is enabled. If the busy flag is enabled, the controller suspends the request until the bus flag is disabled. If the busy flag is disabled, the controller programs the first buffer with the data.

In the second mode, the software unit requests the controller for programming the second and first buffers, and the controller determines whether the busy flag is enabled. If the busy flag is enabled, the controller suspends the request until the busy flag is disabled. If the busy flag is disabled, the controller programs the second and first buffers with the data.

The first and second buffers are implemented on a same RAM device, and the controller simultaneously programs the first and second buffers by the following steps. In the first clock cycle, the data from the software unit is transferred on the bus and sent to the first buffer. The busy flag is enabled in this clock cycle, such that the data on the bus is held for one more clock cycle. In the next cycle, the data on the bus are sent to the second buffer and the busy flag is disabled to release the bus after this cycle. Alternatively, the first and second buffers may also be implemented on two individual RAM devices.

The bus is driven by a bus clock, and the second device comprises a device clock. The controller uses the device clock as a reference for the data copying, and the controller uses the bus clock as a reference for the data synchronization and programming when the second device powers down.

The operating method for the double buffering device is also provided.

### BRIEF DESCRIPTION OF THE DRAWINGS

The following detailed description, given by way of example and not intended to limit the invention solely to the embodiments described herein, will best be understood in conjunction with the accompanying drawings, in which:

FIG. 1 is a diagram illustrating conventional double buffering;

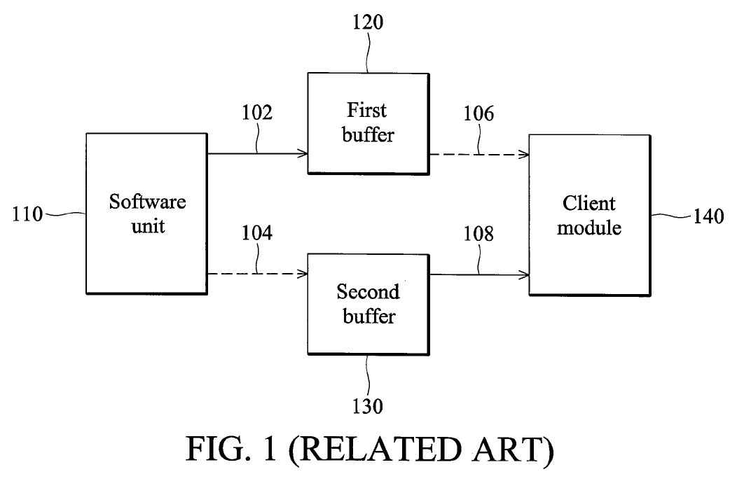

FIGS. 2a and 2b are diagrams illustrating double buffering according to the invention;

FIG. 3 is a timing diagram of single RAM based buffer synchronization;

FIG. 4 shows an embodiment of a double buffering device according to the invention;

FIG. 5 is a timing diagram of buffer programming in mode 2;

FIG. 6 is a timing diagram of dual RAM based buffer synchronization; and

FIG. 7 is a flowchart of the double buffering operating method.

### DETAILED DESCRIPTION

A detailed description of the invention is provided in the following.

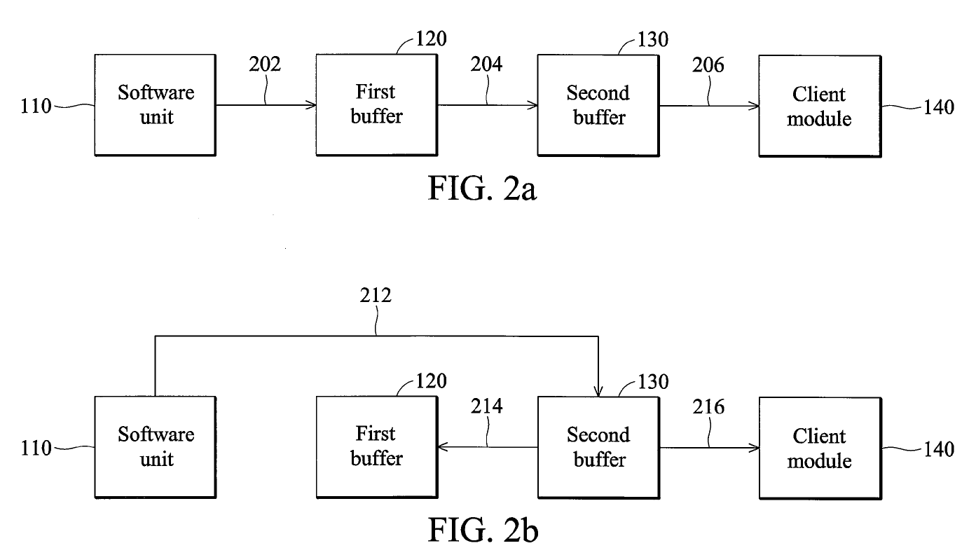

FIGS. 2a and 2b are stage type double buffering diagrams according to the invention. In FIG. 2a, an embodiment of double buffering comprises four elements, software unit 110, first buffer 120, second buffer 130 and client module 140. In mode 1, the software unit 110 only programs the first buffer 120, and the client module 140 accesses the second buffer 130 for data.

In mode 1, the data stored in the first buffer 120 is synchronized with the second buffer 130 automatically. Thus, the software unit 110 does not need to repeatedly program the second buffer 130 and saves microprocessor resources, e.g. computation power.

FIG. 2b shows a mode 2 operation. The software unit 110 directly programs second buffer 130, such that data can be instantly accessed by the client module 140. Simultaneously, the first buffer 120 is synchronized to the second buffer 130 during programming. From another perspective, the first buffer 120 and second buffer 130 are synchronously programmed by the software unit 110 in mode 2. With the design of mode 2, the software unit 110 does not need to program all buffer contents when the double buffer switches from mode 2 back to mode 1. Only changed portion need to be updated. The first buffer 120 and second buffer 130 may be implemented by registers, however, as capacity requirements grow, random access memory (RAM) based architecture is preferable. When implemented by registers, data synchronization between the first buffer 120 and second buffer 130 only requires one data cycle. When implemented by RAM, however, the data synchronization is performed byte by byte, therefore multiple cycles are needed to complete a multi-byte data synchronization.

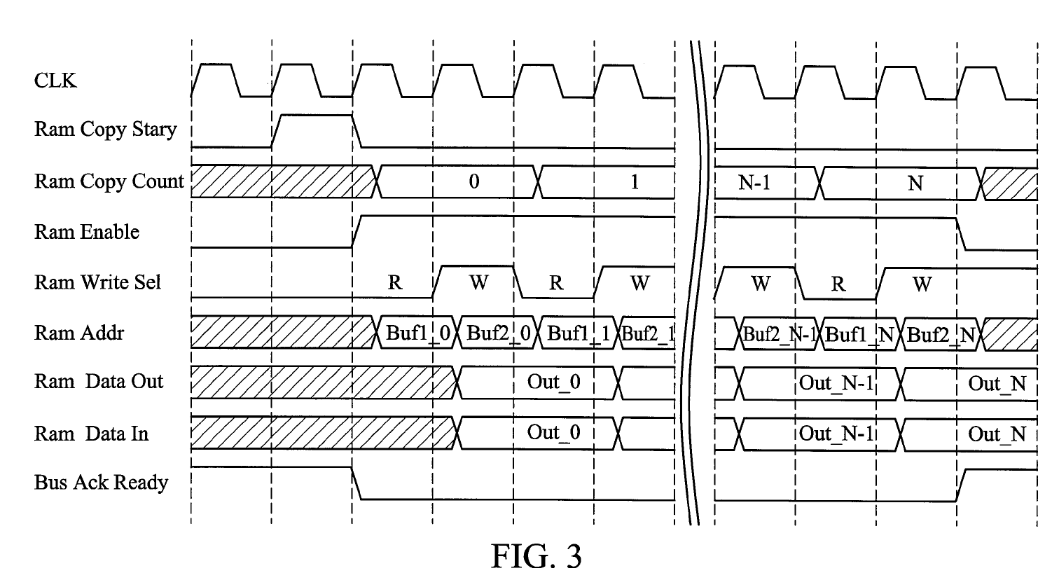

FIG. 3 is a timing diagram of single RAM based buffer synchronization. N-bytes of data is synchronized from the first buffer 120 to second buffer 130. When the synchronization is triggered by a signal RAM_COPY_START, a counter RAM_COPY_COUNT indicates the byte progress. The data bytes are consecutively read from the first buffer 120 and written to the second buffer 130 according to a command signal RAM_WRITE_SEL and an address signal RAM_ADDR. A busy flag BUS_ACK_READY is enabled (pulled low) as the synchronization proceeds, indicating the first buffer 120 and second buffer 130 are occupied, preventing unpredictable access by a third party.

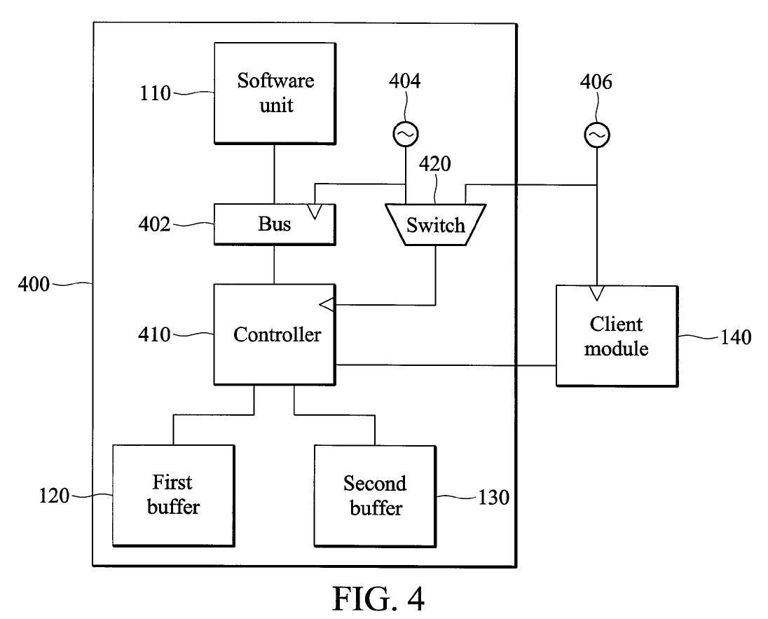

FIG. 4 shows an embodiment of a double buffering device according to the invention. The double buffering module 400 is coupled to a client module 140, and data is provided by the stage type double buffering described in FIGS. 2a and 2b. A controller 410 switches between the model and mode 2 to manage the operations of the first buffer 120 and second buffer 130. In mode 1, the software unit 110 programs the first buffer 120 via the bus 402, and the client module 140 accesses the second buffer 130 through the controller 410. Update data in the first buffer 120 is synchronized to the second buffer 130 periodically, and the synchronization may be performed on demand. In mode 2, the first buffer 120 and second buffer 130 are simultaneously programmed by the software unit 110, thus the synchronization is not required.

As described, if the first buffer 120 and second buffer 130 are implemented by RAM, completion of the data synchronization requires multiple cycles. When synchronizing the second buffer 130 with first buffer 120, a busy flag is enabled to avoid third party access, thus any access request sent from the software unit 110 suspended during the synchronization. The client module 140, however, is defined to have the highest access priority for the second buffer 130. If the client module 140 requests access to the second buffer 130 during the synchronization, the controller 410 suspends the synchronization by holding the counter RAM_COPY_COUNT in FIG. 3. Until the client module 140 completes reading data from the second buffer 130, the synchronization is restored. If the synchronization is not in process when the client module 140 requests to access the second buffer 130, the controller 410 enables the busy flag and performs the data transaction as requested. The busy flag is disabled upon completion of the reading operation. The first buffer 120 and second buffer 130 may be implemented by a same memory device, and can also be two individual memory devices.

In FIG. 4, the bus 402 is driven by a bus clock 404, and the client module 140 comprises a module clock 406. If the first buffer 120 and second buffer 130 are implemented by registers, the bus clock 404 is employed as a clock source. Conversely, if the first buffer 120 and second buffer 130 are implemented by RAM, the module clock 406 is utilized as the clock source CLK shown in FIG. 3. In this way, the client module 140 readying operation, the synchronization process and the software unit 110 programming operation are processed on the same basis. The client module 140, however, maybe powered down, thus, the module clock 406 is unable to serve as the clock source. The double buffering module 400 comprises a 420 for switching the clock source between the bus clock 404 and module clock 406. When the module clock 406 is not present, the 420 switches to utilize the bus clock 404, thus the software unit 110 programming operation can remain operative without the client module 140. The clock switching is applied to the whole double buffering module 400, including the first buffer 120, the second buffer 130 and the controller 410.

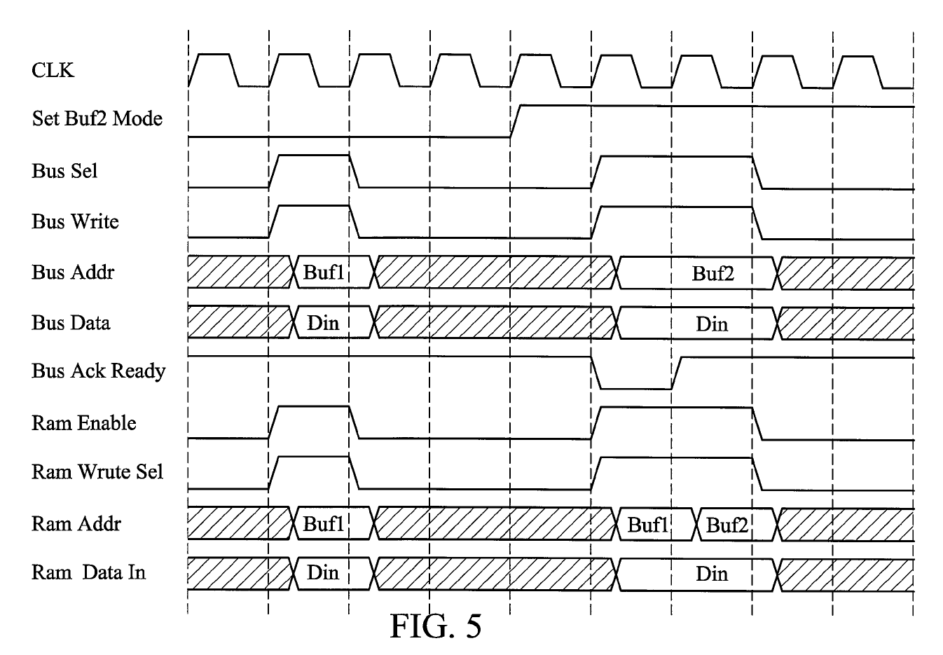

FIG. 5 is a timing diagram of buffer programming in mode 2. When the first buffer 120 and second buffer 130 are two different memory devices, the software unit 110 can simultaneously program the first buffer 120 and second buffer 130 directly in mode 2. If the first buffer 120 and second buffer 130 are implemented by one memory device, a total of two cycles is required to individually write a data byte to the first buffer 120 and second buffer 130. In FIG. 5, when the mode signal SET_BUF2_MODE is set low to indicate mode 1, the software unit 110 programs first buffer 120 via the bus 402 by sending an address signal BUS_ADDR and a data signal BUS_DATA. As the busy flag BUS_ACK_READY is disabled (pulled high), the controller 410 sends writing commands RAM_ENABLE and RAM_WRITE_SEL to the first buffer 120 and passes the address and data signals therein. When the mode signal SET_BUF2_MODE is switched high to indicate mode 2, the software unit 110 sends the address and data signals BUS_ADDR and BUS_DATA to program the second buffer 130. The controller 410 plays a trick by enabling the busy flag BUS_ACK_READY, thus the address and data signals BUS_ADDR and BUS_DATA are transferred on the bus 402. With lowering Bus_Ack_Ready for one cycle, the bus holds the data, i.e., Bus_Addr, Bus_Data and Bus_Write, for one more cycle so that there is sufficient time for completing writing operations of the two buffers. The Bus_Ack_Ready is also used for selecting writing to the first buffer or the second buffer. Simultaneously, the controller 410 delivers writing commands RAM_ENABLE and RAM_WRITE_SEL to the first buffer 120, thus the data signal latched on the bus 402 is sent to the first buffer 120. One cycle thereafter, the controller 410 disables the busy flag BUS_ACK_READY, and the data signal is sent to the second buffer 130 as usual. In this way, a data signal is held on the bus 402 for two cycles, sufficient for both the first buffer 120 and second buffer 130 to update the data. The software unit 110 is not aware of the operation performed by the controller 410 that automatically synchronizes the first buffer 120 and second buffer 130 in mode 2.

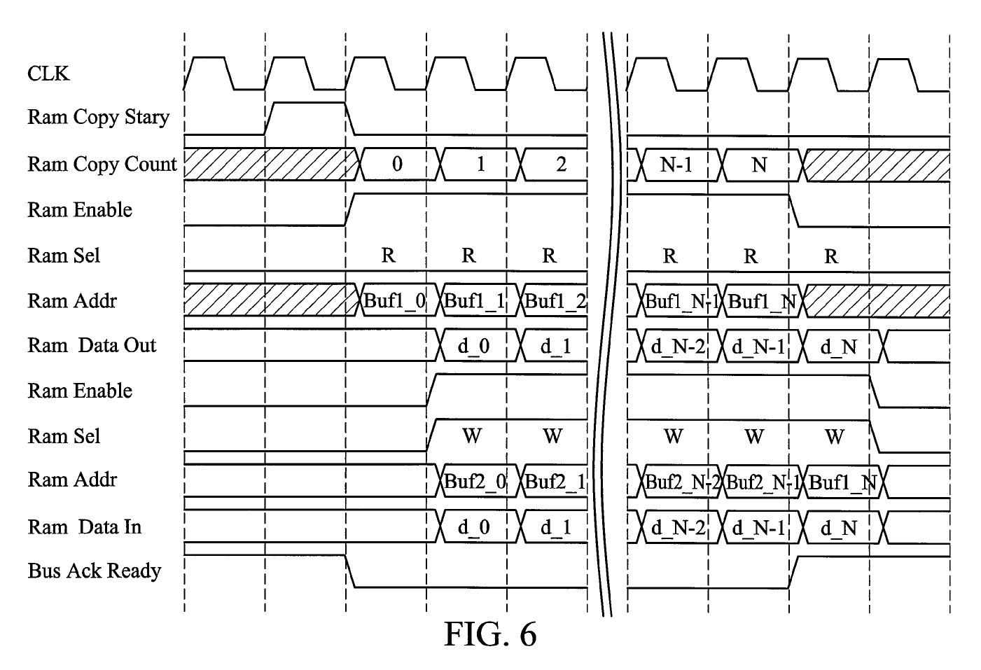

FIG. 6 is a timing diagram of dual RAM based buffer synchronization. Since the first buffer 120 and second buffer 130 are two RAM devices, the implementation is simpler. When the synchronization is triggered by a signal RAM_COPY_START, a counter RAM_COPY_COUNT indicates the byte progress. The data bytes are consecutively read from the first buffer 120 according to a read command signal RAM1_SEL and an address signal RAM1_ADDR, and written to the second buffer 130 according to a write command signal RAM2_SEL and an address signal RAM2_ADDR, with the busy flag BUS_ACK_READY enabled during the first buffer 120 reading process.

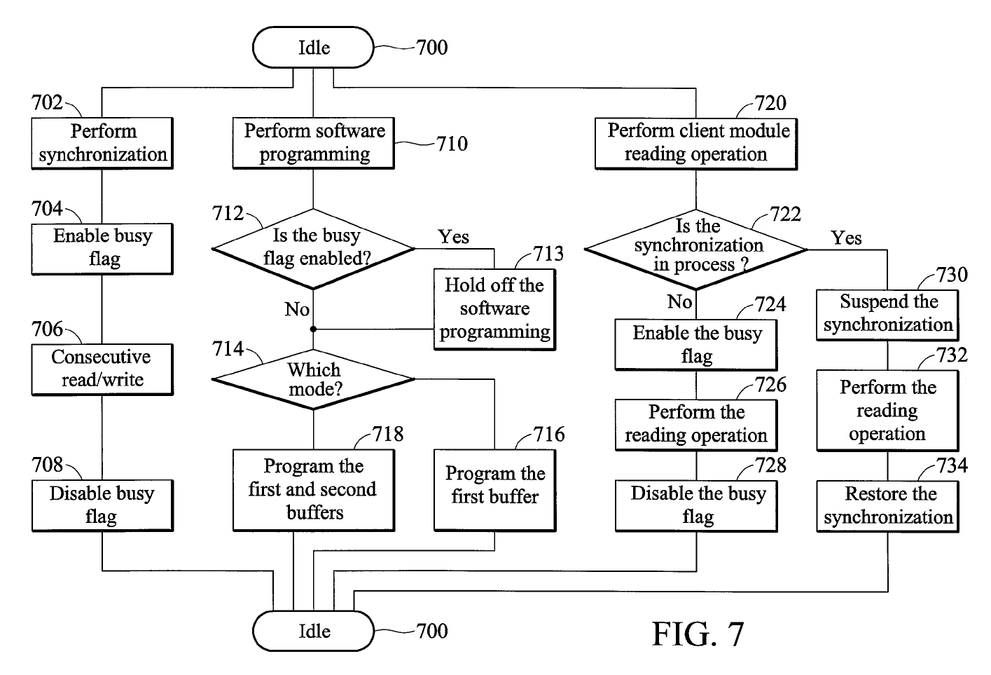

FIG. 7 is a flowchart of the double buffering operating method. In step 700, the double buffering module 400 and client module 140 are initialized and remain idle. In step 702, a synchronization process is triggered. In step 704, a busy flag is enabled, and consecutive read/write operations as shown in FIG. 3 or FIG. 6 are performed in step 706. In step 708, the busy flag is disabled when the synchronization is complete. A soft programming operation may be initialized in step 710. In step 712, the controller 410 determines whether the busy flag is enabled. In step 713, the software unit 110 requests are suspended on the bus 402 when the busy flag is enabled. In step 714, when the busy flag is disabled, the controller 410 determines the mode. In step 716, the controller 410 programs the first buffer 120 in mode 1, and in step 718, the controller 410 simultaneously programs the first buffer 120 and second buffer 130 in mode 2. The client module 140 initializes an access request for the second buffer 130 in step 720. In step 722, the controller 410 checks whether the synchronization is in process. If the synchronization is not processing, the controller 410 enables the busy flag in 724, performs the data transaction from the second buffer 130 to the client module 140 in step 726, and disables the busy flag when the operation is complete in step 728. If the synchronization is in process in step 722, the controller 410 suspends the synchronization in step 730, performs the data transaction in step 726, and restores the synchronization in step 734. When operations in steps 708, 718, 716, 718 and 734 are complete, the process returns to step 700.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A double buffering operating method for a first device providing data to a second device, wherein the first device coupled to a first buffer and a second buffer, and the method comprising:
in a first mode:
programming the first buffer with the data;
synchronizing the data from the first buffer to the second buffer; and
copying the data from the second buffer to the second device, in a second mode:
simultaneously programming the first and second buffers with the data; and
copying the data from the second buffer to the second device.

2. The double buffering operating method as claimed in claim 1, wherein:
the first and second buffers are random access memory devices; and
the data are provided to the buffers via a bus.

3. The double buffering operating method as claimed in claim 2, wherein:
the data comprises a plurality of bytes stored in the first buffer; and
the synchronization comprises:
enabling a busy flag to indicate that the buffers are occupied,
reursively reading the data byte by byte in the first buffer;
recursively writing the data byte by byte to the second buffer; and
disabling the busy flag when the synchronization completes.

4. The double buffering operating method as claimed in claim 3, further comprising:
receiving a data access request from the second device;
if the synchronization is in process when receiving the data access request, suspending the synchronization to perform the copying from the second buffer to the second device, and restoring the synchronization when the copying is complete; and
if the synchronization is not in process when receiving the data access request, enabling the busy flag, performing the copying from the second buffer to the second device, and disabling the busy flag when the copying is complete.

5. The double buffering operating method as claimed in claim 3, further comprising:
in the first mode:
receiving a request for programming the first buffer;
determining whether the busy flag is enabled,
if the busy flag is enabled, suspending the request until the busy flag is disabled; and
if the busy flag is disabled, programming the first buffer with the data; in the second mode:
receiving a request for programming the second and first buffers;
determining whether the busy flag is enabled;
if the busy flag is enabled, suspending the request until the busy flag is disabled; and
if the busy flag is disabled, programming the second and first buffers with the data.

6. The double buffering operating method as claimed in claim 2, wherein: the first and second buffers are implemented on a same RAM device, and the step of simultaneously programming the first and second buffers comprises:
transmitting the data from the first device on the bus in a first clock cycle;
sending the data to the first buffer in the first clock cycle;
enabling the busy flag for holding the data on the bus for one more clock cycle in the first clock cycle;
sending the data on the bus to the second buffer in a next clock cycle; and
disabling the busy flag to release the bus after the next clock cycle.

7. The double buffering operating method as claimed in claim 2, wherein the first and second buffers are implemented on two individual RAM devices.

8. The double buffering operating method as claimed in claim 2, further comprising:
using the second device clock as a reference for the steps of copying and synchronizing; and
using the bus clock as a reference for the step of programming when the second device powers down.

9. A double buffering device providing data to a second device, comprising:
a controller, controlling accesses for the data;
a first buffer and a second buffer, coupled to the controller, storing the data;
a bus, coupled to the controller for data delivery;
a software unit, providing data to the buffers via the bus, wherein:
in a first mode:
the software unit programs the first buffer with the data;
the controller synchronizes the data from the first buffer to the second buffer; and
the controller copies the data from the second buffer to the second device; in a second mode:
the software unit simultaneously programs the first and second buffers with the data; and
the controller copies the data from the second buffer to the second device.

10. The double buffering device as claimed in claim 9, wherein the first and second buffers are random access memory (RAM) devices.

11. The double buffering device as claimed in claim 10, wherein:
the data comprises a plurality of bytes stored in the first buffer; and
the controller synchronizes the first and second buffers by:
enabling a busy flag to indicate the buffers are occupied,
recursively reading the data byte by byte in the first buffer,
recursively writing the data byte by byte to the second buffer, and
disabling the busy flag when the synchronization completes.

12. The double buffering device as claimed in claim 11, wherein:
when a data access request is received from the second device, the controller determines whether the synchronization is in process;
if the synchronization is in process, the controller suspends the synchronization, copies the data from the second buffer to the second device, and restores the synchronization when the copying is complete; and
if the synchronization is not in process, the controller enables the busy flag, copies the data from the second buffer to the second device, and disables the busy flag when the copying is complete.

13. The double buffering device as claimed in claim 12, wherein:
in the first mode:
the software unit requests the controller for programming the first buffer;
the controller determines whether the busy flag is enabled;
if the busy flag is enabled, the controller suspends the request until the busy flag is disabled; and
if the busy flag is disabled, the controller programs the first buffer with the data;
in the second mode:
the software unit requests the controller for programming the second and first buffers;
the controller determines whether the busy flag is enabled;
if the busy flag is enabled, the controller suspends the request until the busy flag is disabled; and
if the busy flag is disabled, the controller programs the second and first buffers with the data.

14. The double buffering device as claimed in claim 10, wherein: the first and second buffers are implemented on a same RAM device, and the controller simultaneously programs the first and second buffers by:
enabling the busy flag for a clock cycle when the bus latches a data byte from the software unit, such that the data byte is sent to the first buffer, and
disabling the busy flag after the clock cycle, such that the data byte is sent to the second buffer.

15. The double buffering device as claimed in claim 10, wherein the first and second buffers are implemented on two individual RAM devices.

16. The double buffering device as claimed in claim 10, wherein:
the bus is driven by a bus clock, and the second device comprises a device clock,
the controller uses the device clock as a reference for the data copying and synchronization; and
the controller uses the bus clock as a reference for the data programming when the second device powers down.
